(19) United States
(12) Patent Application Publication
(10) Pub. No.: US 2025/0153206 A1
(43) Pub. Date: May 15, 2025

(54) PORTABLE JOINT-COMPOUND TEXTURE SPRAYER

(71) Applicant: ELSA YAMILETH REYES ZACARIAS, Tampa, FL (US)

(72) Inventor: ELSA YAMILETH REYES ZACARIAS, Tampa, FL (US)

(21) Appl. No.: 18/507,585

(22) Filed: Nov. 13, 2023

(51) Int. Cl. B05B 9/08

(52) U.S. Cl. CPC B05B 9/0811

(57) ABSTRACT

A portable joint-compound texture sprayer that delivers a joint-compound to a primed drywall to produce an orange peel textured appearance. The portable joint compound texture sprayer comprises of a handle section that has an operating switch. The handle section receives a rechargeable battery. A reciprocal cycle linear actuator motor attaches to the handle section. A piston tube section attaches to the front side of the handle section, a rod of a piston is housed within the piston tube section and the rod of the piston connects to a reciprocal rod of the reciprocal cycle linear actuator motor. A canister connector section attaches to the piston tube section. The canister connector receives a canister, the canister connector section attaches to the piston tube section and to a spray nozzle section that has a spray nozzle. A tube system carries the joint-compound from the canister to the spray nozzle.

### BACKGROUND

The present invention is directed to a portable joint-compound texture sprayer.

The inventor of the present invention is in the business of spraying drywalls with a joint compound so that the walls have a textured and artistic appearance.

Presently, texture is applied to drywalls either by the art of spreading the joint compound by hand using various techniques or by using pressurized hopper gun and spraying the compound on the walls that require texture. There are also manual portable devices that use manual force to spray the joint compound onto the walls: the manual portable devices require the user to pump the devices so that a pressure is created within the device that will spray the joint compound outwards from the devices.

The present invention is a portable device that does not require an air compressor or manual force to apply the texture to the walls that will produce an orange peel texture. An orange peel texture is a texture that resembles the skin of an orange peel.

Orange peel texture is created as follows: first, the walls in which texture is applied to is primed so that the walls are smooth and dirt free; next, the drywall compound that is used to texture the walls is mixed with water so that the texture has a consistency of a thick paint or soupy pancake batter, thereby making a watered joint-compound; then, the watered joint-compound is poured into a hooper that is connected to a sprayer that is normally attached to an air compressor; and lastly, the watered joint-compound is spayed on to the walls that will be textured.

The present invention eliminates the need of having an air-compressor to spray the texture on to the walls that are going to be textured. The invention also eliminates the need to use a manual device to spray the texture onto the walls.

### SUMMARY

The present invention is directed to a portable joint-compound texture sprayer that delivers a joint-compound to a primed drywall to produce an orange peel textured appearance.

The portable joint compound texture sprayer comprises of a handle section that has an operating switch. The handle section receives a rechargeable battery. A reciprocal cycle linear actuator motor attaches to the handle section. A piston tube section attaches to the handle section, a rod of a piston is housed within the piston tube section, and the rod of the piston connects to a reciprocal rod of the reciprocal cycle linear actuator motor. A canister connector section attaches to the piston tube section. The canister connector receives a canister. The canister connector section attaches to the piston tube section and to a spray nozzle section. The spray nozzle section has a spray nozzle. A tube system carries the joint-compound from the canister to the spray nozzle.

An object of the present invention is to provide a device that will eliminate the need of using an air-compressor to texture walls.

Another object of the present invention is to provide a device that will be portable and that will not require the manual pumping of a device to spray the material on the drywalls being textured.

### BRIEF DESCRIPTION OF THE DRAWINGS

These and other features, aspects, and advantages of the present invention will become better understood with regards to the following description, appended claims, and drawings where:

FIG. 1 shows a perspective view of the present invention;

FIG. 2 shows a side view of the canister and the canister connector of the present invention;

FIG. 3 shows the piston tube section of the present invention is a retracted and an extended position;

FIG. 4 shows a top plan view of the reciprocal cycle linear actuator motor of the present invention;

FIG. 5 shows a perspective side view of the handle section of the present invention;

FIG. 6 shows an exploded view of the spray section and canister section of the present invention; and

FIG. 7 shows a pictorial representation of how the elements of the present invention work together.

### DESCRIPTION

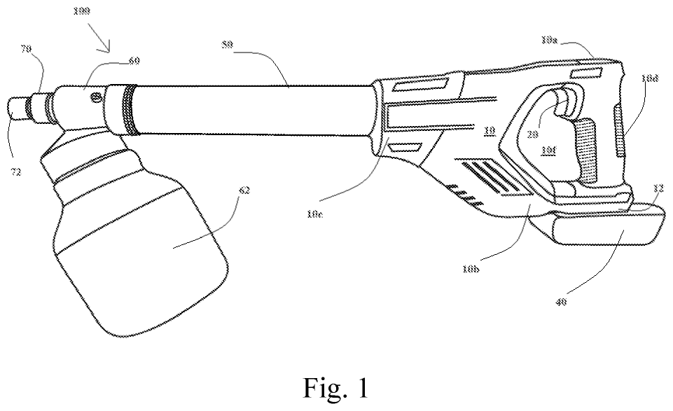

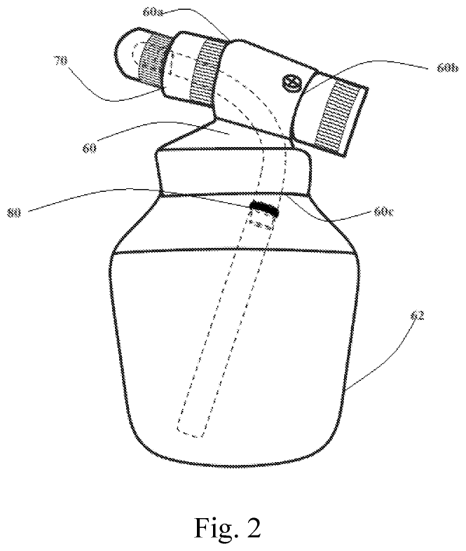

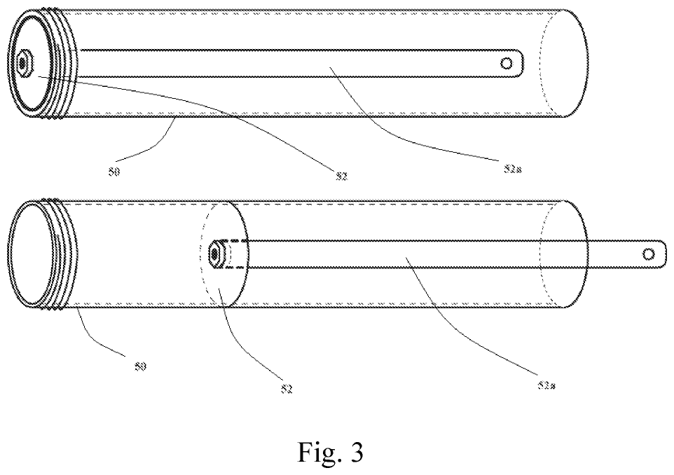

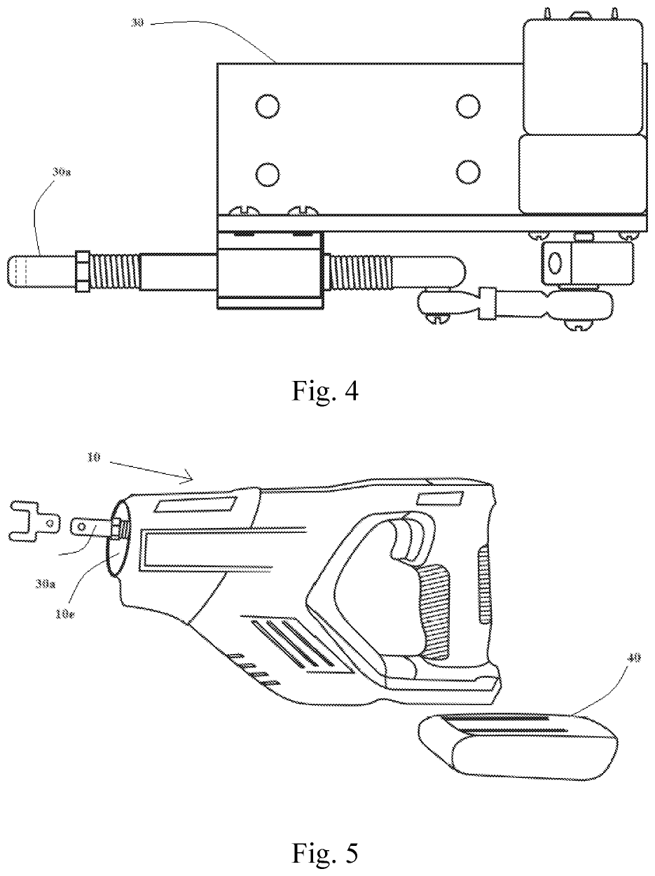

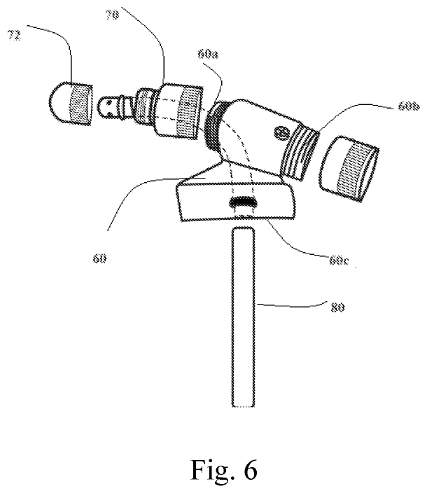

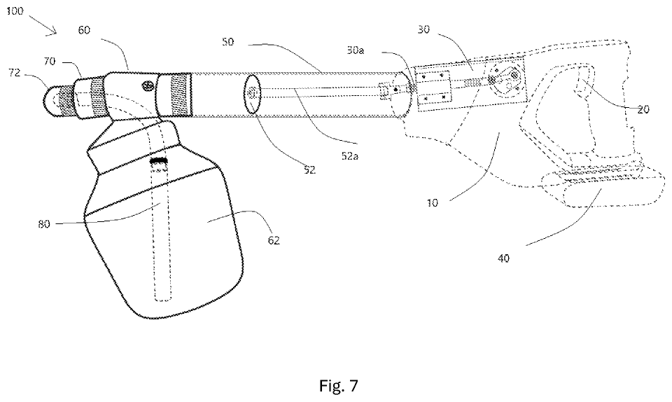

As seen in FIGS. 1-7, the present invention is a portable joint-compound texture sprayer 100 that delivers a joint-compound to a primed drywall to produce an orange peel textured appearance.

The portable joint-compound texture sprayer 100 comprises a handle section 10, that has a top side 10a, a bottom side 10b, a front side 10c, and a rear side 10d, the bottom side 10b defines a battery receiver 12, the front side defines an aperture 10e, an inner grip aperture 10f is positioned above the battery receiver 12 and is located adjacent to the rear side 10d and the top side 10a of the handle section 10. A variable speed switch 20 attaches to handle section 10 at a position that borders the inner grip aperture 10f. A reciprocal cycle linear actuator motor 30 attaches to a top inner section 10g of the handle section, the battery 40, the variable speed switch 20, and the reciprocal cycle linear actuator motor 30 are operatively wired to each other. A piston tube section 50 attaches to the front side 10c of the handle section 10, a rod 52a of a piston 52 is housed within the piston tube section 50, the rod 52a of the piston 52 connects to a reciprocal rod 30a of the reciprocal cycle linear actuator motor 30. A canister connector section 60 attaches to the piston tube section 50, the canister connector section 60 is hollow and has a front side 60a, a rear side 60b, and a bottom side 60c, the bottom side 60c receives a canister 62, the rear side of the canister connector section 60 attaches to the piston tube section 50, and the front side of the canister connection sections 60a attaches to a spray nozzle section 70, the spray nozzle section 70 has a spray nozzle 72. And, a tube system 80 attaches to the spray nozzle 72.

An advantage of the present invention is that it provides a device that eliminates the need of using an air-compressor to texture walls.

Another advantage of the present invention is that it provides a device that is portable and that does not require the manual pumping of a device to spray the material on the drywalls being textured.

While the inventor's description contains many specificities, these should not be construed as limitations of the portable joint-compound texture sprayer portable joint-compound texture sprayer of the present invention, but rather as an exemplification of several preferred embodiments thereof, any other variations may be possible. Accordingly, the scope should be determined not by the embodiments illustrated, but by the specification, the drawings, and the claims and any legal equivalent thereof.

What is claimed is:

1. A portable joint-compound texture sprayer that delivers a joint-compound to a primed drywall to produce an orange peel textured appearance, the portable joint compound texture sprayer comprises:
a handle section, that has a top side, a bottom side, a front side, and a rear side, the bottom side defines a battery receiver, the front side defines an aperture, an inner grip aperture is positioned above the battery receiver and is located adjacent to the rear side and the top side of the handle section;
a variable speed switch attaches to handle section at a position that borders the inner grip aperture;
a reciprocal cycle linear actuator motor attaches to a top inner section of the handle section, the battery, the variable speed switch, and the reciprocal cycle linear actuator motor are operatively wired together;
a piston tube section attaches to the front side of the handle section, a rod of a piston is housed within the piston tube section, the rod of the piston connects to a reciprocal rod of the reciprocal cycle linear actuator motor;
a canister connector section attaches to the piston tube section, the canister connector section is hollow and has a front side, a rear side, and a bottom side, the bottom side receives a canister, the rear side of the canister connector section attaches to the piston tube section, and the front side of the canister connection sections attaches to a spray nozzle section, the spray nozzle section that has a spray nozzle; and
a tube system attaches to the spray nozzle.
